(19) United States
(12) Patent Application Publication
(10) Pub. No.: US 2014/0362574 A1
(43) Pub. Date: Dec. 11, 2014

(54) MODULAR LIGHT EMITTING DIODE LIGHTING SYSTEM

(71) Applicant: Brian Barrett, Ottawa (CA)

(72) Inventor: Brian Barrett, Ottawa (CA)

(21) Appl. No.: 14/287,246

(22) Filed: May 27, 2014

Related U.S. Application Data
(60) Provisional application No. 61/831,220, filed on Jun. 5, 2013.

(51) Int. Cl. F21S 4/00; F21K 99/00

(52) U.S. Cl. CPC F21S 4/008; F21K 9/30
USPC 362/249.03; 362/249.06

(57) ABSTRACT

Discloses a Light Emitting Diode (LED) lighting system comprising one or more LED lighting fixture and at least one connector for each LED lighting fixture. The LED lighting fixture has a light Emitting Diode (LED) light strip comprising a substrate, at least one LED light and at least two conductive strips. The LED light is electrically connected to the conductive strips. Each connector comprises at least one conductive contact and/or at least one socket configured to connect at least two LED lighting fixture and/or to connect one LED light fixture and a plug or power cord. At least two LED lighting fixture is connected by inserting each end of the connector to the transverse side of one LED lighting fixture without soldering such that the conductive contact comes in contact with the conductive strip.

### CROSS-REFERENCE TO RELATED APPLICATION

This application claims benefit of priority of U.S. Provisional patent application Ser. No. 61/831,220, filed Jun. 5, 2013, entitled “MODULAR LED LIGHTING SYSTEM”, owned by the assignee of the present application and herein incorporated by reference 5 in its entirety.

### TECHNICAL FIELD

The present disclosure relates generally to lighting system. Embodiments of the disclosure are particularly related to a modular Light Emitting Diode (LED) lighting system that can form any required length and shape without soldering.

### BACKGROUND

Strip lighting is often used to provide even light over an extended area or to mount under a shelf or cupboard. However, finding a strip of the right length or shape for the space where it is needed can be difficult. Additionally, powering strips lights can be difficult. There may not be a power source close to where the lights are to be mounted or the power source may not be close to the end of the strip light where the connector or plug is located.

Various LED lighting system are used for illumination. One prior U.S. Pat. No. 8,641,229 B2, relates to lighting strips, flexible lighting systems and devices, which are waterproof. The lighting strips are modular and are capable of being physically and electrically connected with one another to provide lighting systems that are waterproof and adaptable to many situations. The modular lighting strips comprises a non-conductive substrate strip comprising an electrical circuit; a plurality of high brightness LEDs operable connected to the electrical circuit; a colloid layer comprising polyurethane resin providing a waterproof coating over the substrate, the circuit, and the LEDs; and a plug at one end and a socket at an opposing end of the substrate which is integrally formed with the strip to provide for waterproof electrical interconnection of two or more circuits or to a power supply. The lighting strips can be used in particular for back lighting, accent lighting, aisle or path lighting, contour lighting, elegant interior decoration, holiday decorations, or landscape lighting.

Another prior art, US patent application, US 2013/0021811 A1, discloses an integrally-formed single-piece flexible light strip comprising a substrate populated with at least one LED light circuit. A clear flexible plastic housing is molded around the LED light circuit to completely encapsulate the light circuit. A flexible electrical cable and contoured strain relief for the electrical cable are also integrally formed as part of the light strip to maintain complete environmental and physical protection and eliminate any non-flexible portions of the light strip such as when a connector is used. The light strip is manufactured in a cost efficient manner, and is impervious to moisture penetration and highly resistant to physical damage, thereby allowing the light strip to be used in a variety of applications and environments. The shape of the illustrated light strip is specially designed for attachment to the round tubing of a bicycle frame. The light strip includes an electrical circuit allowing a reduction in the number of wires between the strip and its associated external control and power.

One another prior art, US patent application, US 2008/0192462 A1 discloses a low-profile strip illumination device comprising a substrate supporting an elongate heat conductor and positively and negatively energized elongate rails. A plurality of spaced apart light emitting diodes (LEDs) is mounted so as to be powered by the elongate rails. The LEDs are arranged generally adjacent the elongate heat conductor so that a heat flow path is defined from each LED to the elongate heat conductor and to the environment.

The U.S. Pat. No. 7,973,274 B2, discloses an integrally formed single piece light emitting diode (LED) light wire that provides a smooth, uniform lighting effect from all directions of the LED light wire. The integrally formed single piece LED light wire includes a support substrate, a conductive base formed on the support substrate, the conductive bus comprising a plurality of conductive bus elements, at least one conductive segment arranged between the plurality of conductive bus elements, the at least one conductive segment comprising at least one LED. The integrally formed single piece LED light wire may include built-in sensors/detectors and/or a plurality of LED modules with individually controlled LEDs via microprocessors. The integrally formed single piece LED light wire may also include an interlocking alignment system which permits the coupling of at least two LED light wires. Further, a plurality of the integrally formed single piece LED light wires may create a lighting panel.

The Chinese utility model, CN 203131553 U presents a plug with an LED light band, including LED light band and a plug, the LED light band and the plugs are connected by wires, the LED light junction with said sleeve has a hot wire shrink tube. The utility model in connection with the LED light wire is sheathed with a heat-shrinkable tube, which can be prevented by connecting the wire to the LED light with a short circuit or a wire of a fall, to improve the stability with the use of LED light. In this process, LED light can penetrate with transparent or translucent glass bends and elbows in the use of crystal lighting, lighting and landscaping features lighting play itself and the environment.

The LED light band/strips used in the prior art lighting systems are designed in such a way that when the LED strips/bands are cut at any desired length as per the user requirement and connected with other LED strips/bands or to the power source, it has to be soldered. Soldering of LED strips/bands or power source by user as per the requirement is difficult, error prone and time consume. Also not all the users will be familiar with the soldering work to meet their required shape and length.

A need, therefore, exists for an improved LED lighting system, to overcome the above drawbacks.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

It is, therefore, one aim of the disclosed embodiments to provide for a light Emitting Diode (LED) light strip comprising a substrate having two parallel edges and one or more layers, at least one LED light mounted on at least one side of substrate and at least two conductive strips mounted on at least one side of the substrate and extended along a length of the substrate such that the LED light is electrically connected to the conductive strips. The substrate can be a rigid non-conductive or insulated conductive, or partially conductive, or conductive planar substrate.

It is, therefore, one aim of the disclosed embodiments to provide for LED light strip in which the substrate is rectangular. The substrate comprises epoxy coated aluminum, fiberglass reinforced polymer glass, polymers, fiber reinforced polymer, paper reinforced polymer or other rigid material.

It is, therefore, one aim of the disclosed embodiments to provide for LED light strip in which the LED light and the conductive strips are mounted on the same side of the substrate.

It is, therefore, one aim of the disclosed embodiments to provide for LED light strip in which the LED light and the conductive strips are mounted on the different sides of the substrate.

It is, therefore, one aim of the disclosed embodiments to provide for LED light strip in which the LED light is mounted on the center line between the two parallel edges of the substrate and between the conductive strips.

It is, therefore, one aim of the disclosed embodiments to provide for LED light strip in which a set of two or more LEDs connected in series with or without a resistor or with or without a voltage or current limiting element, wherein each set of LEDs is connected to the conductive strips.

It is, therefore, one aim of the disclosed embodiments to provide for LED light strip in which the extra conductive strips are added to the conductive strips to connect the conductive strips to a controller to dim or otherwise control the LEDs.

It is, therefore, one aim of the disclosed embodiments to provide for LED light strip in which the LED light strip can be cut to any required length at any region between the LED lights and can be reconnected with or without soldering.

It is, therefore, one another aim of the disclosed embodiments to provide for a Light Emitting Diode (LED) fixture comprising an LED light strip, a housing comprising at least one transverse and longitudinal side that are configured to hold the LED light strip. The transverse side has a planar bottom and a notch into which the LED light strip slides along the interior of the longitudinal side.

The light Emitting Diode (LED) light strip has a substrate having two parallel edges and one or more layers, at least one LED light mounted on at least one side of substrate and at least two conductive strips mounted on at least one side of the substrate and extended along a length of the substrate such that the LED light is electrically connected to the conductive strips. The substrate can be a rigid non-conductive or insulated conductive, or partially conductive, or conductive planar substrate.

It is, therefore, one another aim of the disclosed embodiments to provide for a Light Emitting Diode (LED) fixture that has a planar non-opaque surface mounted opposite and parallel to the planar bottom, wherein the a LED strip is located between the planar bottom and non-opaque surface, facing the non-opaque surface.

It is, therefore, yet another aim of the disclosed embodiments to provide for a Light Emitting Diode (LED) fixture in which the transverse side has another notch into which the non-opaque surface slides along the interior of the longitudinal side.

It is, therefore, one another aim of the disclosed embodiments to provide for a Light Emitting Diode (LED) fixture in which the non-opaque surface is translucent.

It is, therefore, another aim of the disclosed embodiments to provide for a Light Emitting Diode (LED) fixture in which the non-opaque surface is transparent.

It is, therefore, another aim of the disclosed embodiments to provide for a Light Emitting Diode (LED) lighting system comprising one or more LED lighting fixture and at least one connector for each LED lighting fixture. Each connector comprises at least one conductive contact and/or at least one socket configured to connect at least two LED lighting fixture and/or to connect one LED light fixture and a plug or power cord. At least two LED lighting fixture is connected by inserting each end of the connector to the transverse side of one LED lighting fixture without soldering such that the conductive contact comes in contact with the conductive strip. One LED light fixture and a plug or power cord is connected by inserting the one end of the connector to the transverse side of one LED lighting fixture and other end of connector to the plug or power cord without soldering such that the conductive contact comes in contact with the conductive strip and the socket comes in contact with the plug or power cord.

It is, therefore, another aim of the disclosed embodiments to provide for a Light Emitting Diode (LED) lighting system in which at least one connector is an angled connector for connecting two lighting fixtures that are at an angle to each other.

It is, therefore, another aim of the disclosed embodiments to provide for a Light Emitting Diode (LED) lighting system in which the conductive contact comprises springs loaded flat pin to firmly attach the LED lighting fixture and/or to the plug or power cord without soldering.

It is, therefore, another aim of the disclosed embodiments to provide for a Light Emitting Diode (LED) lighting system in which the conductive contact comprises a switch.

It is, therefore, another aim of the disclosed embodiments to provide for a Light Emitting Diode (LED) lighting system in which the conductive contact comprises a button that when pushed connects or momentarily connects two or more conductive strips together.

It is, therefore, another aim of the disclosed embodiments to provide for a Light Emitting Diode (LED) lighting system in which the conductive contact can be connected in any orientation.

Other aspects and advantages of the invention will become apparent from the following detail description, taken in conjunction with the accompanying drawings, illustrating by way of example the principles of the invention.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 is an illustration of a perspective view of a LED light strip, in accordance with the disclosed embodiment;

FIG. 2 is an illustration of a perspective view of lighting fixture for the LED light strip depicted in FIG. 1, in accordance with the disclosed embodiment;

FIG. 3 is an another illustration of a perspective view of lighting fixture depicted in FIG. 2, in accordance with the disclosed embodiment;

FIG. 4 is an another illustration of a perspective view of lighting fixture depicted in FIG. 3 showing the LED light strip partially inserted, in accordance with the disclosed embodiment;

FIG. 5 is an illustration of a perspective view of lighting fixture depicted in FIG. 3 further inserted with a transparent surface plane, in accordance with the disclosed embodiment;

FIG. 6 is an another illustration of a perspective view of lighting fixture depicted in FIG. 3 further inserted with a translucent surface plane, in accordance with the disclosed embodiment;

FIG. 7 is an illustration of exploded perspective view of a LED lighting system, in accordance with the disclosed embodiment;

FIG. 8 is an illustration of assembled view of the LED lighting system depicted in FIG. 7, in accordance with the disclosed embodiment;

FIG. 9 is an illustration of a straight connector for use in LED lighting system depicted in FIGS. 7-8, in accordance with the disclosed embodiment;

FIG. 10 is an illustration of a straight connector to be connected to the lighting fixture depicted in FIGS. 2-6, in accordance with the disclosed embodiment;

FIG. 11 is an illustration of an angled connector for use in LED lighting system depicted in FIGS. 7-8, in accordance with the disclosed embodiment;

FIG. 12 is an illustration of the angled connector of FIG. 11 to be connected to lighting fixture depicted in FIGS. 2-6, in accordance with the disclosed embodiment;

FIG. 13 is an illustration of the angled connector of FIG. 11 connected to lighting fixture depicted in FIGS. 2-6, in accordance with the disclosed embodiment;

FIG. 14 is an illustration of an angled connector with spring for use in LED lighting system depicted in FIGS. 7-8, in accordance with the disclosed embodiment;

FIG. 15 is an illustration of an straight connector with an opening for connecting lead wires for use in LED lighting system depicted in FIGS. 7-8, in accordance with the disclosed embodiment; and

FIGS. 16-17B is an illustration of circuit diagrams that are used in LED lighting system depicted in FIGS. 7-8, in accordance with the disclosed embodiment.

### DETAILED DESCRIPTION OF ILLUSTRATIVE EMBODIMENTS

The particular values and configurations discussed in these non-limiting examples can be varied and are cited merely to illustrate at least one embodiment and are not intended to limit the scope thereof.

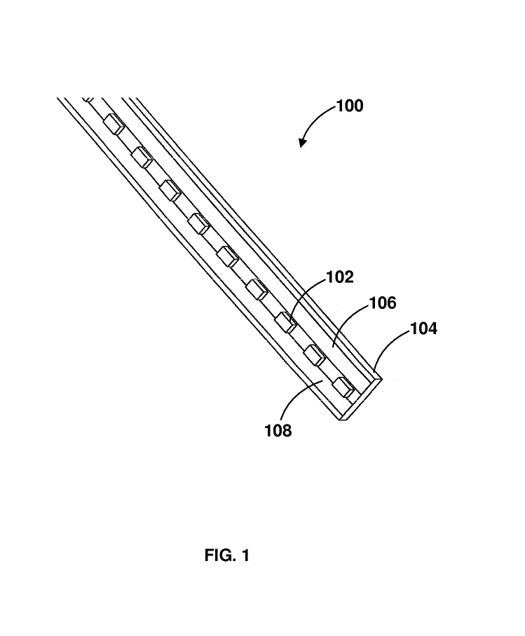

Referring to FIG. 1, a, LED (Light Emitting Diode) light strip 100 is disclosed. The LED light strip 100 has a substrate 104 having two edges, one or more LED lights 102 and two conductive strips 106 and 108. The substrate 104 can be a rigid non-conductive or insulated conductive, or partially conductive, or conductive planar substrate. The two or more LED lights 102 and two parallel conductive strips 106 and 108 are mounted on one side of the substrate 104 such that the LED lights 102 are electrically connected to the two conductive strips 106 and 108. The conductive strips 106 and 108 can be mounted on the same side as the LED lights 102 or on opposite sides.

The substrate 104 can be rectangular and comprises of epoxy coated aluminum, fiberglass reinforced polymer glass, polymers, fiber reinforced polymer, paper reinforced polymer or other rigid material. The LED lights 102 can be mounted on the center line between the two parallel edges of the substrate 104 and between the conductive strips 106 and 108. The LED lights 102 can be a set of two or more LEDs 102 connected in series with or without a resistor or with or without a voltage or current limiting element, wherein each set of LEDs lights 102 is connected to the conductive strips 106 and 108. One or more extra conductive strips can be added to the conductive strips 106 and 108 to connect the conductive strips 106 and 108 to a controller to dim or otherwise control the LEDs lights 102. In one embodiment the LED light 102 can be cut to any required length at any region between the LED lights 102 and reconnected with or without soldering.

In some embodiments, the conductive strips comprise of tin plated copper. Other examples of materials that can be used for the conductive strips include, but are not limited to aluminum, brass, bronze, silver, gold, unplated copper. Non-limiting examples of light that can be used are surface mount or through holes LEDs or OLEDs.

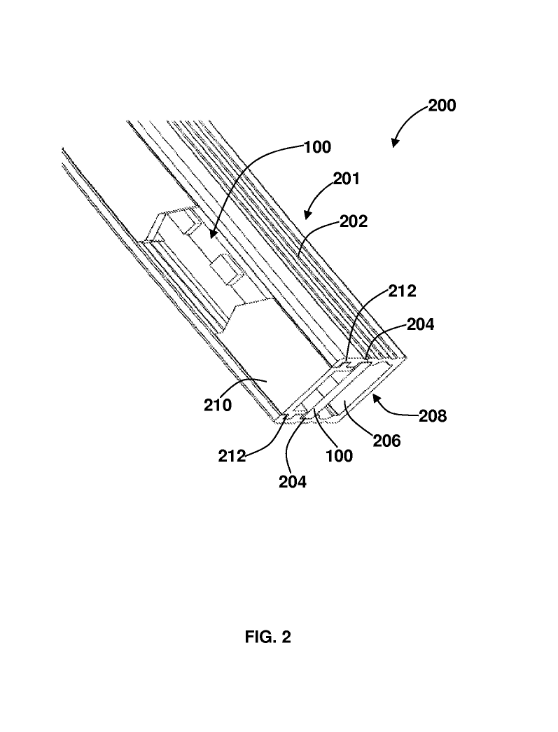

Referring to FIG. 2, a Light Emitting Diode (LED) fixture 200 for housing the light strip 100 depicted in FIG. 1 is disclosed. The LED housing 201 comprising at least one transverse side 208 and longitudinal side 202 that are configured to hold the LED light strip 100. The transverse side 208 has a planar bottom 206 and a notch 204 into which the LED light strip 100 slides along the interior of the longitudinal side 202. The transverse side 208 has another notch 212 into which the non-opaque surface 210 slides along the interior of the longitudinal side 202. The planar non-opaque surface 210 is mounted opposite and parallel to the planar bottom. The LED strip 100 depicted in FIG. 1 is located between the planar bottom 206 and non-opaque surface 210, facing the non-opaque surface 210.

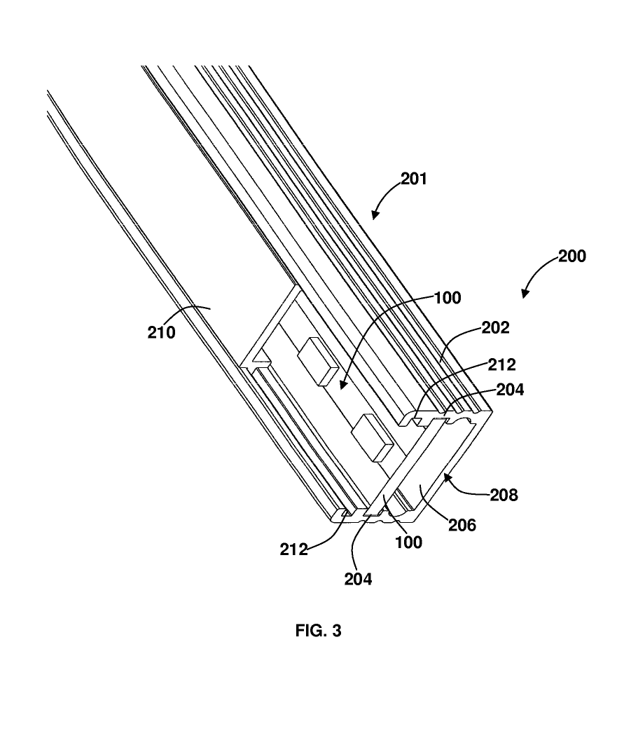

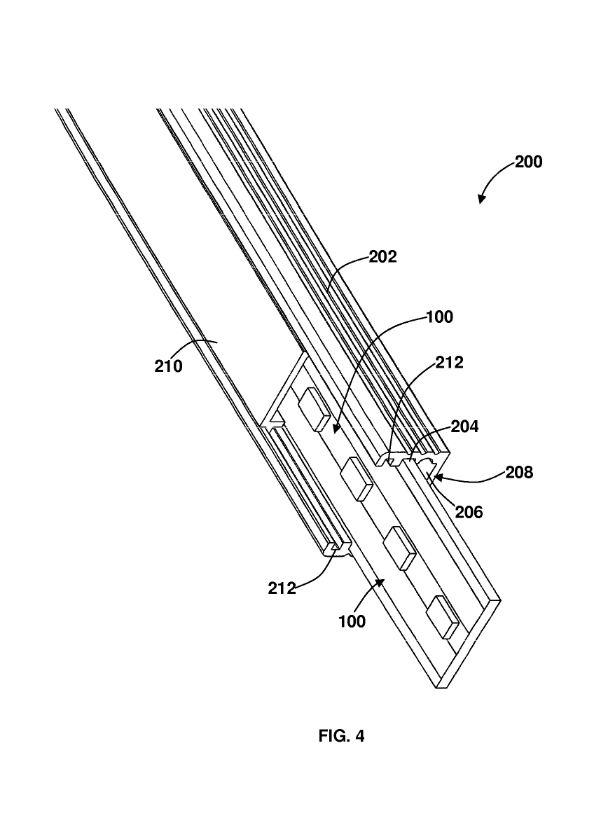

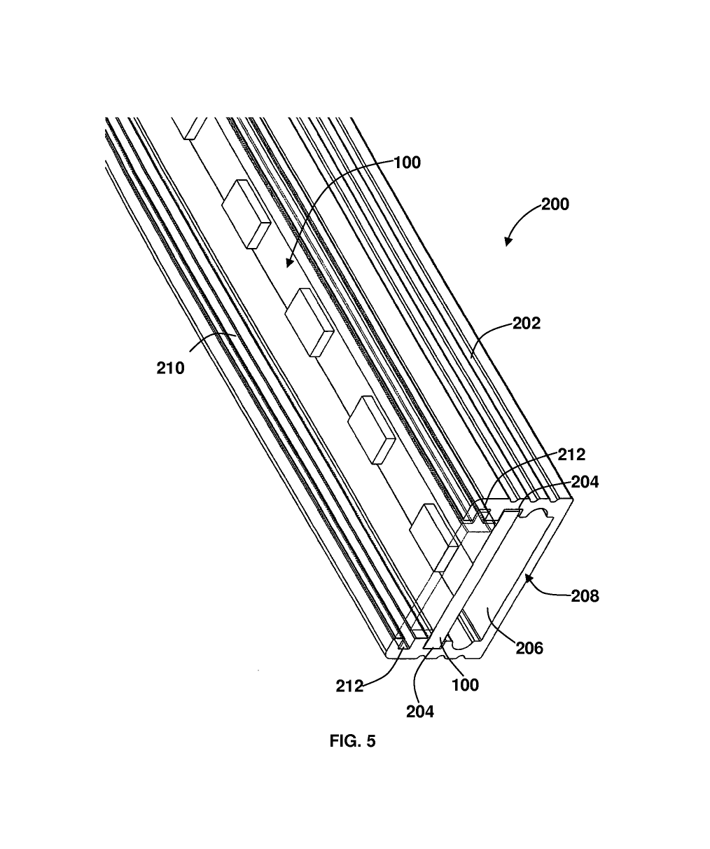

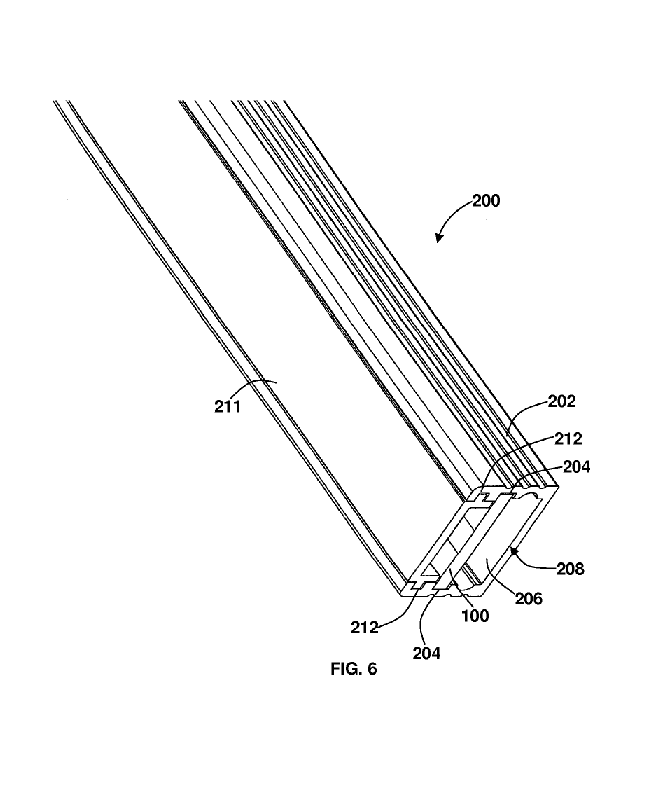

In FIG. 3, the non-opaque surface 210 is slide back away from one of the ends of the housing 201. In FIG. 4, the non-opaque surface 210 is slide back away from one of the edges of the housing 201 and the LED light strip 100 is partially inserted into the housing. The non-opaque surface 210 can be transparent or translucent. FIGS. 5-6 show the transparent and translucent non-opaque surfaces 210 and 211 in place respectively.

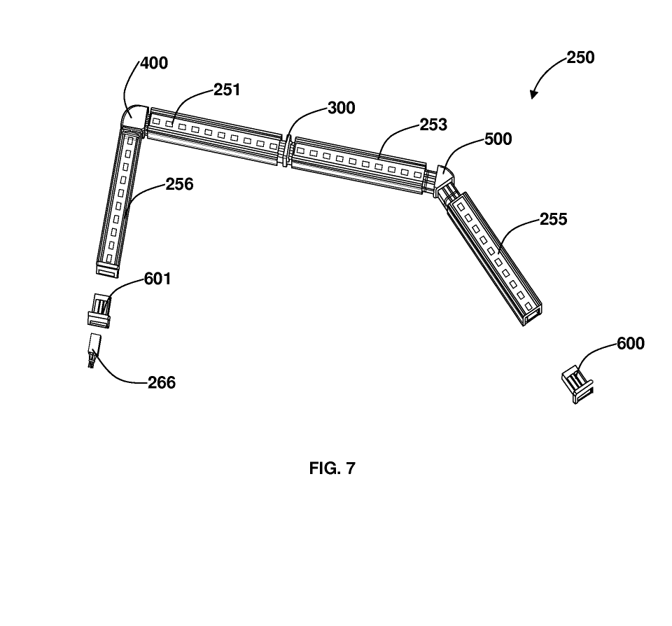

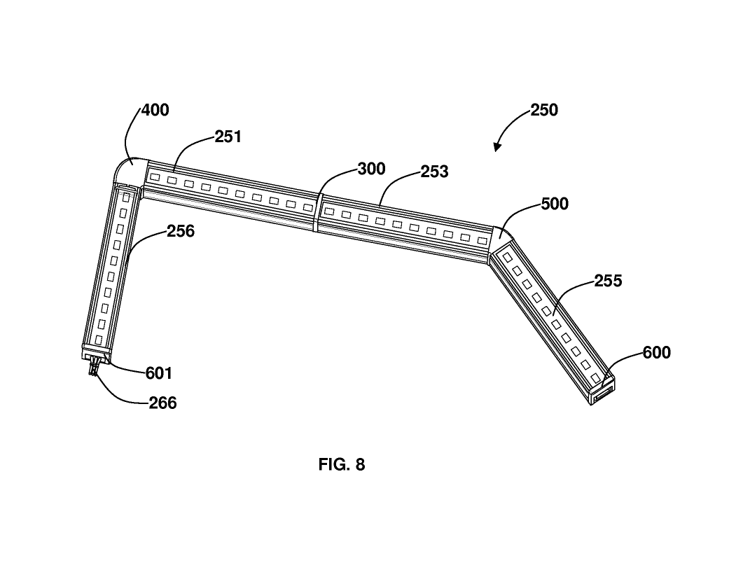

Referring FIGS. 7-8, an LED lighting system 250 has one or more LED lighting fixture for example LED lighting fixture 200 depicted in FIG. 2-6. In an example shown in figures, four LED lighting fixtures 251, 253, 255 and 256 are used. It should be noted that any number of lighting fixtures can be used. The system 250 has four LED lighting fixtures 251, 253, 255 and 256 connected with five connectors 300, 400, 500, 600 and 601 and power cord and/or plug 266. Each connector comprises at least one conductive contact and/or at least one socket configured to connect at least two LED lighting fixture and one LED light fixture and a plug. One end of the LED lighting fixtures 251 and 256 are connected with the connector 400 and one end of the LED lighting fixtures 253 and 255 are connected with another angled connector 500. The other ends of the end of the LED lighting fixtures 251 and 253 care connected together with the straight connector 300. Thus the four LED lighting fixtures 251, 253, 255 and 256 are connected to form the LED lighting system 250. The other end of the LED lighting fixtures 255 and 256 are connected to one end of the connectors 600 and 601 respectively. The other end of the connectors 600 and 601 can be connected to the power cord or plug 266 as shown. FIG. 8 is the assembled view of the LED lighting system depicted in FIG. 7.

It should be noted that the LED lighting fixtures are connected together by inserting each end of the connector to the transverse side of one LED lighting fixture without soldering such that the conductive contact comes in contact with the conductive strip. Similarly one LED light fixture and a plug or power cord or conductive wire are connected together by inserting the one end of the connector to the transverse side of one LED lighting fixture and other end of connector to the plug or power cord without soldering such that the conductive contact comes in contact with the conductive strip and the socket comes in contact with the plug or power cord.

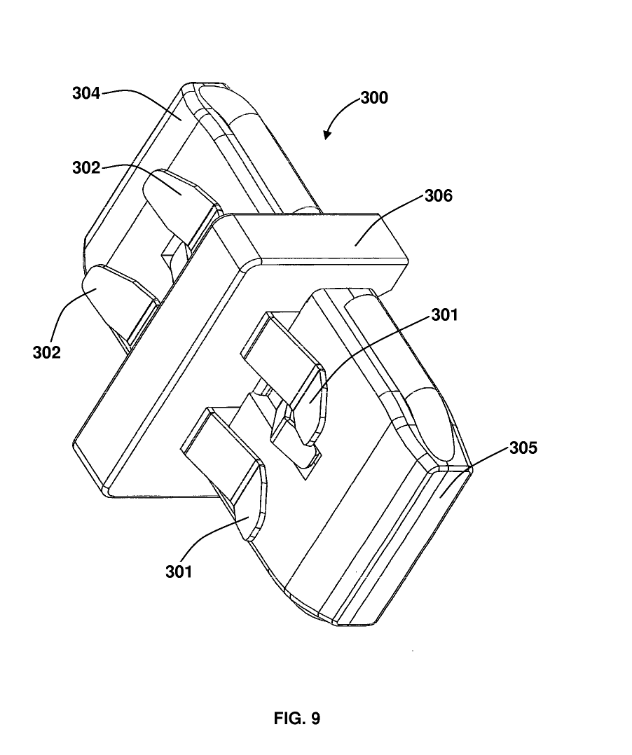

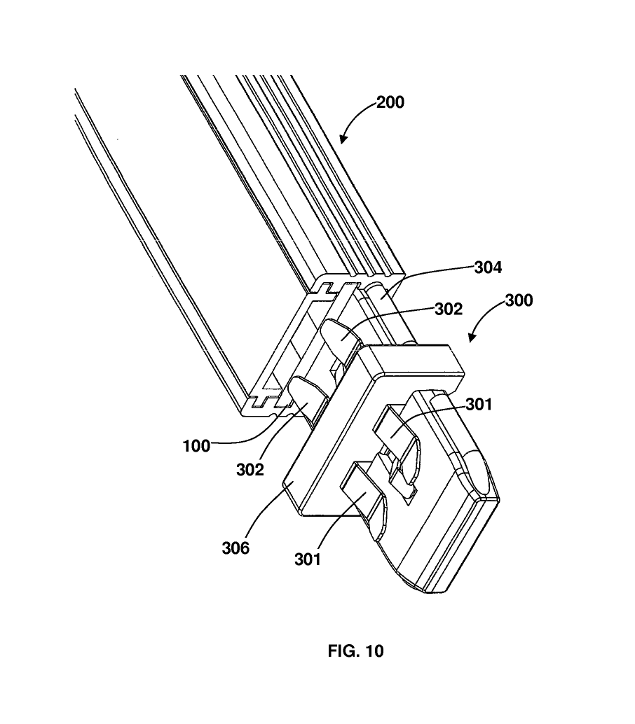

Referring to FIG. 9, one of the straight connectors 300 used in LED lighting system 250 depicted in FIGS. 7-8 is shown. The connector 300 has a straight centre wall 306, four conductive contacts 301 and 302 and conductor ends 304 and 305. FIG. 10 shows the end 304 of the straight connector 300 inserted into the planar bottom 206 along the transverse side 208 of the LED lighting fixture 200 depicted in FIG. 2 until the center wall 306 such that the conductive contacts 302 comes in contact with the conductive strips 106 and 108 depicted in FIG. 1.

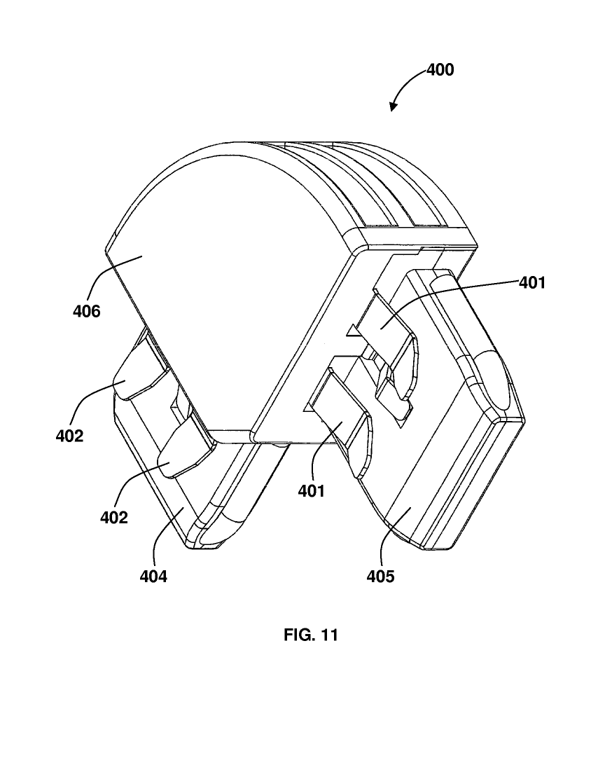

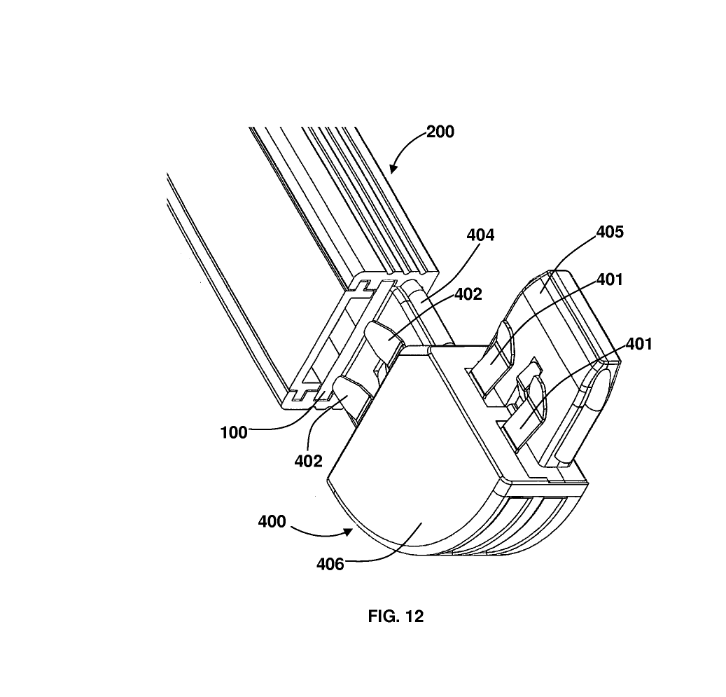

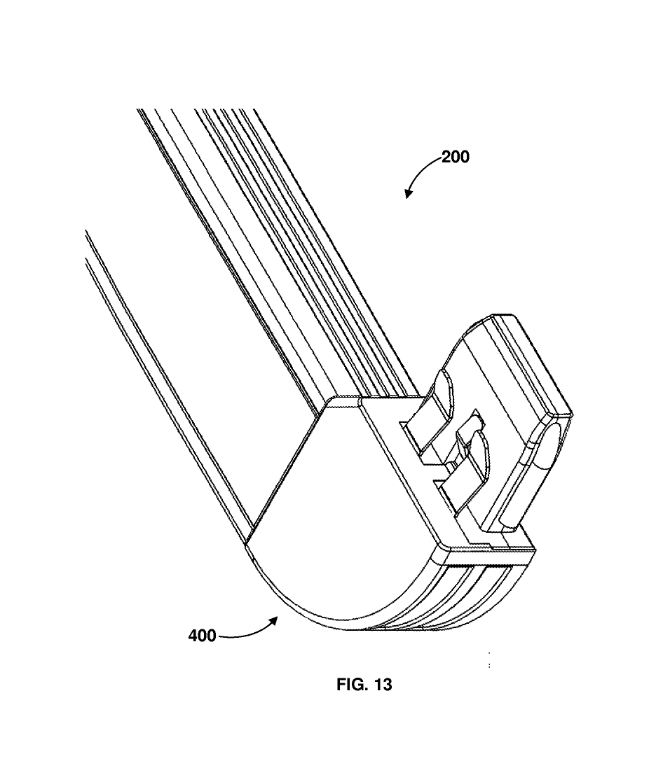

Referring to FIG. 11, one of the angled connector 400 used in LED lighting system 250 depicted in FIGS. 7-8 is shown. The connector 400 has an angled wall 406, four conductive contacts 401 and 402 and connector ends 404 and 405. FIG. 12 shows the end 404 of the straight connector 400 inserted into the planar bottom 206 along the transverse side 208 of the LED lighting fixture 200 depicted in the FIG. 2 until the angled wall 406 such that the conductive contacts 402 comes in contact with the conductive strips 106 and 108 depicted in FIG. 1. FIG. 13 shows the connector 400 inserted into the LED lighting fixture 200 depicted in FIGS. 7-8.

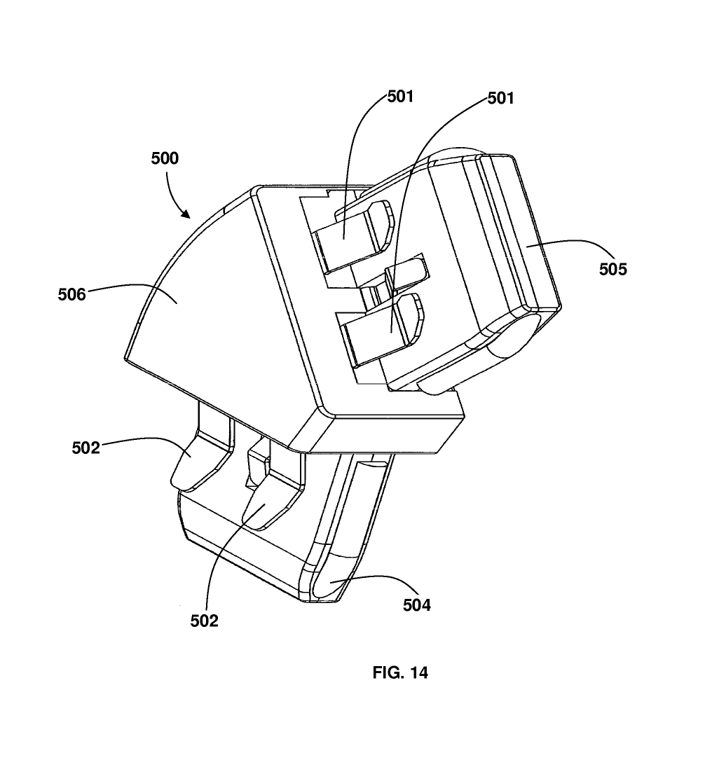

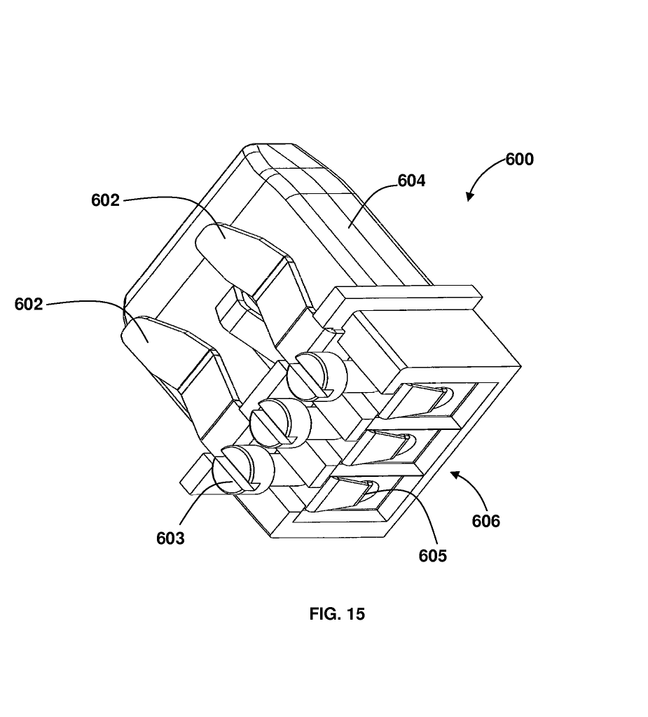

Similarly now referring to FIG. 14, another angled connector 500 used in LED lighting system 250 depicted in FIGS. 7-8 is shown. The connector 500 has an angled wall 506, four conductive contacts 501 and 502 and connector ends 504 and 505. FIG. 15 shows the view of straight end connector 600 to which power cord 266 is connected as used in LED lighting system 250 depicted in FIGS. 7-8. The end connector 600 has a port for accepting a plug. As shown in FIG. 15, the end connector 600 has openings 605 into which bare wires can be inserted and held in place with screws 603.

It should be noted that the angled connector 400 is right angled (ninety degrees) and the angled connector 500 has forty five degree angle. The connectors 300, 400 and 500 have springs for connecting to conductive strips. The connectors 300, 400 and 500 can be connected on one or either both sides to two LED lighting fixture or one LED lighting fixture and a plug or power cord Also, any angle of the connector is possible, making the shape of the lighting system customizable. The system 250 includes one explanatory combination of connector and any numbers of configurations are possible. In some embodiments, at least one connector comprises a switch. In some embodiments, the switch can be used to turn one lighting fixture ON or OFF. In some embodiments a switch on a connector can turn the entire system ON or OFF.

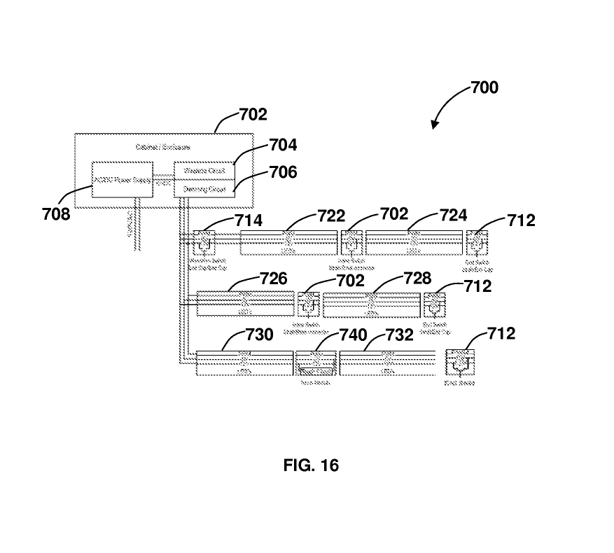

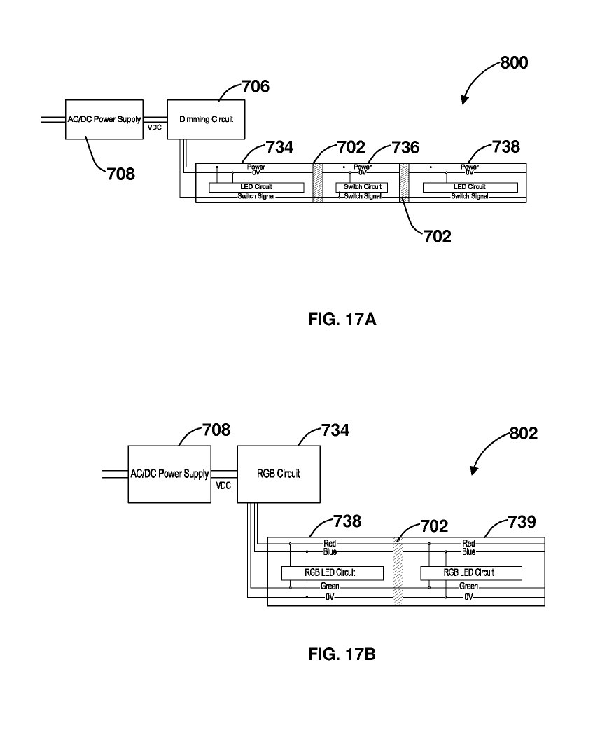

FIGS. 16-17B is an illustration of circuit diagrams that are used in LED lighting system depicted in FIGS. 7-8, in accordance with the disclosed embodiment. As shown in FIG. 16, LED lighting system 700 has a cabinet or enclosure 702 for housing a AC/DC power supply 708 connected to a wireless circuit 704 and a dimming circuit 706. The wireless circuit 704 and/or the dimming circuit 706 can be connected to connectors and/or LED lighting fixtures. The LED lighting fixture pairs 722 and 724, 726 and 728, and 730 and 732 are connected together using the connectors 702 and 704 as shown. The LED lighting fixtures 724, 728 and 732 are connected to the end connector or switch 712. As shown, the connectors 730 and 726 are connected to the wireless circuit 704 and/or the dimming circuit 706. The connector 714 connects the LED lighting fixture 722 and the wireless circuit 704 and/or dimming circuit 706. Thus any customizable LED lighting system can be designed as per user requirement. The connector 740 can be a touch module or connecting the LED lighting fixtures 730 and 732.

FIG. 17A shows the connector configuration 800 for connecting three LED lighting fixtures 735, 736 and 738 using the connectors 702, which are then connected to the dimming circuit 706 and power supply 708. Brightness of the LED lighting fixture can be adjusted using the dimming circuit 706. FIG. 17B shows the connector configuration 802 for connecting two LED lighting fixtures 738 and 739 using the connectors 702, which are then connected to the RGB (Red, Green and Blue) circuit 734 and power supply 708. The color of the LED lights in LED lighting fixtures 738 and 739 can be set by connecting to the RGB circuit 734 as shown.

With the systems disclosed, there is no need for soldering connectors to join lighting strips together or to connect to a power source. A connector, such as those that have been described above, can simply be pushed onto an end of the fixture and make contact with the conductive strips. Additionally, it is possible to create modular LED light strips that can be cut to any length and that can be powered from either end. When multiple lighting strips are connected, they can be powered from any connecting point or ends. In some embodiments, the LEDs are recessed and therefore, no valance is required. The lighting fixture can be powered by a battery or through an AC/DC adaptor from an AC outlet.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed y the following claims.

Although embodiments of the current disclosure have been described comprehensively, in considerable detail to cover the possible aspects, those skilled in the art would recognize that other versions of the disclosure are also possible.

What is claimed is:

1. A Light Emitting Diode (LED) light strip comprising:
a rigid non-conductive, or insulated conductive, or partially conductive, or conductive planar substrate having two parallel edges and one or more layers;
at least one LED light mounted on at least one side of substrate; and
at least two conductive strips mounted on at least one side or edge of the substrate and extended along a length of the substrate such that the LED light is electrically connected to the conductive strips.

2. The LED light strip of claim 1, wherein the substrate is rectangular.

3. The LED light strip of any one of claims 1 to 2, wherein the substrate comprises epoxy coated aluminum, fiberglass reinforced polymer glass, polymers, fiber reinforced polymer, paper reinforced polymer or other rigid material.

4. The LED light strip of any one of claims 1 to 3, wherein the LED light and the conductive strips are mounted on the same side of the substrate.

5. The LED light strip of any one of claims 1 to 4, wherein the LED light and the conductive strips are mounted on the different sides of the substrate.

6. The LED light strip of any one of claims 1 to 5, wherein the LED light is mounted on the center line between the two parallel edges of the substrate and between the conductive strips.

7. The LED light strip of any one of claims 1 to 6, wherein the LED light comprising a set of two or more LEDs connected in series with or without a resistor or with or without a voltage or current limiting element, wherein each set of LEDs is connected to the conductive strips.

8. The LED light strip of any one of claims 1 to 7, wherein one or more extra conductive strips are added to the conductive strips to connect the conductive strips to a controller to dim or otherwise control the LEDs.

9. The LED light strip of any one of claims 1 to 8 is cut to any required length at any region between the LED lights and can be reconnected with or without soldering.

10. The Light Emitting Diode (LED) fixture comprising:
a LED light strip as claimed in any one of claims 1 to 9; and
a housing comprising at least one transverse and longitudinal sides that are configured to hold the LED light strip, wherein the transverse side has a planar bottom and a notch into which the LED light strip slides along the interior of the longitudinal side.

11. The LED fixture of claim 10, further comprising a planar non-opaque surface mounted opposite and parallel to the planar bottom, wherein the a LED strip is located between the planar bottom and non-opaque surface, facing the non-opaque surface.

12. The LED fixture of claim 11, wherein the transverse side has another notch into which the non-opaque surface slides along the interior of the longitudinal side.

13. The LED fixture of claim 11 or 12, wherein the non-opaque surface is translucent.

14. The LED fixture of any one of claims 10 to 13, wherein the non-opaque surface is transparent.

15. A Light Emitting Diode (LED) lighting system comprising:
one or more LED lighting fixture claimed in any one of claims 8 to 12;
at least one connector for each LED lighting fixture, wherein each connector comprises at least one conductive contact and/or at least one socket configured to:
connect at least two LED lighting fixture by inserting each end of the connector to the transverse side of one LED lighting fixture without soldering such that the conductive contact comes in contact with the conductive strip; and
connect one LED light fixture and a plug or power cord or conductive wire by inserting the one end of the connector to the transverse side of one LED lighting fixture and other end of connector to the plug or power cord without soldering such that the conductive contact comes in contact with the conductive strip and the socket comes in contact with the plug or power cord.

16. The LED lighting system of claim 15, wherein at least one connector is an angled connector for connecting two lighting fixtures that are at an angle to each other.

17. The LED lighting system of any one of claims 15 to 16, wherein the conductive contact comprises springs loaded flat pin to firmly attach the LED lighting fixture and/or to the plug or power cord without soldering.

18. The LED lighting system of any one of claims 15 to 17, wherein the conductive contact comprises a switch.

19. The LED lighting system of claim 8 and or 15 to 17, wherein the conductive contact comprises a button that when pushed connects or momentarily connects two or more conductive strips together.

20. The LED lighting system of claim 8 and or 15 to 19, wherein the conductive contact can be connected in any orientation.
